(19) United States
(12) Patent Application Publication
(10) Pub. No.: US 2016/0098186 A1
(43) Pub. Date: Apr. 7, 2016

(54) ELECTRONIC DEVICE AND METHOD FOR PROCESSING HANDWRITTEN DOCUMENT

(71) Applicant: Kabushiki Kaisha Toshiba, Tokyo (JP)

(72) Inventor: Chikashi Sugiura, Hamura Tokyo (JP)

(21) Appl. No.: 14/667,953

(22) Filed: Mar. 25, 2015

(30) Foreign Application Priority Data
Oct. 2, 2014 (JP) 2014-203785

(51) Int. Cl. G06F 3/0488; G06T 11/60; G06F 3/041

(52) U.S. Cl. CPC G06F 3/04883; G06F 3/041; G06T 11/60

(57) ABSTRACT

According to one embodiment, an electronic device performs a process of a process of erasing one or more strokes from the handwritten document in response to an operation for collectively erasing at least one stroke corresponding to an erasing are. The erasing area is determined by at least a track size of an additional stroke received in an erasing mode. The electronic device executes, when the erasing area is larger than a first size, a first process of erasing at least one stroke distinguishable as an object to be erased in a first erasing manner. The electronic device executes, when the erasing are is not larger than the first size, a second process of erasing at least one stroke in a second erasing manner different from the first erasing manner.

### CROSS-REFERENCE TO RELATED APPLICATIONS

This application is based upon and claims the benefit of priority from Japanese Patent Application No. 2014-203785, filed Oct. 2, 2014, the entire contents of which are incorporated herein by reference.

### FIELD

Embodiments described herein relate generally to a technique of allowing hand written inputs.

### BACKGROUND

Various types of electronic devices such as tablets, PDA's, smartphones, for instance, have been developed in recent years. The electronic devices of these types mostly have a touchscreen display to facilitate a user input operation.

Furthermore, even a technique for erasing a stroke from a handwritten document has been recently developed.

However, a technique for easily erasing many strokes from a handwritten document has not been hitherto developed yet.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an electronic device in one embodiment.

FIG. 2 is an exemplary view illustrating a cooperative operation between the electronic device of FIG. 1 and some external devices.

FIG. 3 is a view exemplarily illustrating handwritten characters written by hand on the touchscreen display of the electronic device of FIG. 1.

FIG. 4 is an exemplary view for explaining time-series data corresponding to the handwritten characters illustrated in FIG. 3.

FIG. 5 is an exemplary view illustrating the configuration of the electronic device of FIG. 1.

FIG. 6 is an exemplary block diagram illustrating the functional configuration of a handwritten note application program executed by the electronic device of FIG. 1.

FIG. 7 is an exemplary view illustrating an editing view capable of handwritten input.

FIG. 8 is an exemplary view for explaining a normal erasure (a narrow-range erasure) in which some strokes are erased by an erasing tool (a stylus).

FIG. 9 is an exemplary view for explaining one example of a wide-range erasure in which many strokes are collectively erased by the erasing tool.

FIG. 10 is an exemplary view for explaining a process of canceling the wide-range erasure.

FIG. 11 is an exemplary view for explaining another example of the wide-range erasure.

FIG. 12 is an exemplary view for explaining still another example of the wide-range erasure.

FIG. 13 is an exemplary view for explaining still another example of the wide-range erasure.

FIG. 14 is an exemplary flowchart illustrating an erasing process executed by the handwritten note application program.

### DETAILED DESCRIPTION

Various embodiments will be described hereinafter with reference to the accompanying drawings.

In general, according to one embodiment, an electronic device comprises a display controller and circuitry. The display controller displays on a screen a handwritten document comprising a plurality of strokes. The circuitry performs a process of erasing one or more strokes from the handwritten document in response to an operation for collectively erasing at least one stroke corresponding to an erasing are. The erasing area is determined by at least a track size of an additional stroke received in an erasing mode. When the erasing area is larger than a first size, the circuitry performs a first process of erasing at least one stroke distinguishable as an object to be erased in a first erasing manner. When the erasing are is not larger than the first size, the circuitry performs a second process of erasing at least one stroke in a second erasing manner different from the first erasing manner.

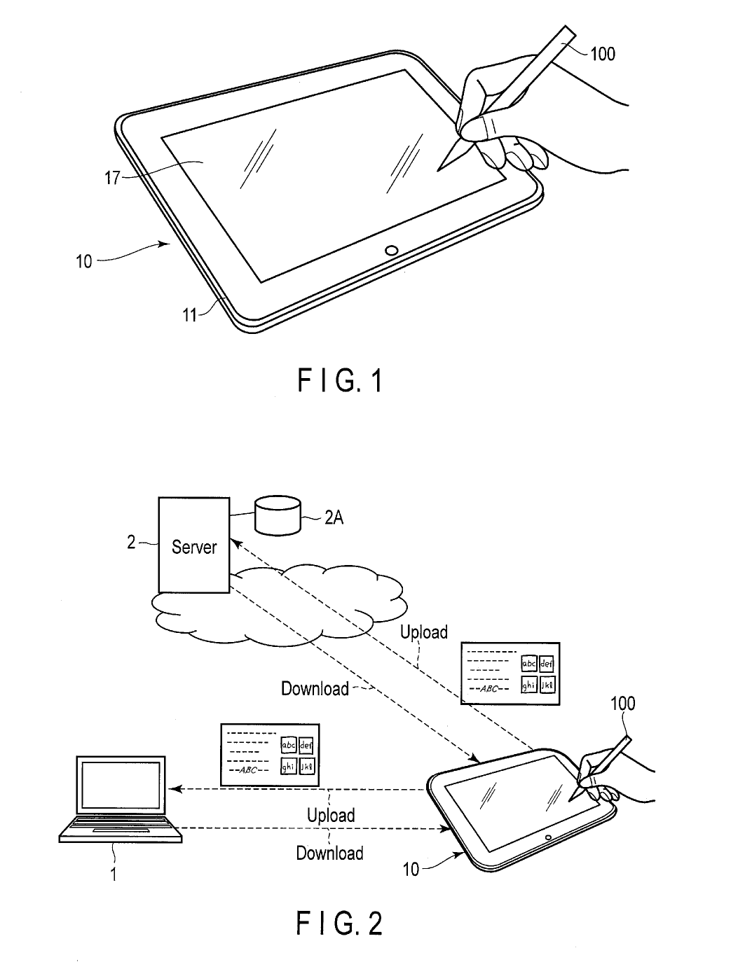

FIG. 1 is a perspective view illustrating an external appearance of an electronic device in the embodiment. The electronic device is, for example, a stylus-based portable electronic device which enables handwriting input by a stylus or a finger. The electronic device includes a tablet computer, a notebook computer, a smartphone, a PDA, etc. In the following, let us suppose that the electronic device is a tablet computer 10. The tablet computer 10 is a portable electronic device called a tablet or a slate computer. The tablet computer 10 comprises as illustrated in FIG. 1 a body 11 and a touchscreen display 17. The body 11 has a thin box shaped case. The touchscreen display 17 is placed over the upper surface of the body 11.

The touchscreen display 17 comprises a flat panel display and a sensor. The sensor detects a contact position where a stylus or a finger touches the screen of the flat panel display. The flat panel display may be a liquid crystal display (an LCD), for instance. An electrostatic capacitance system touchpanel or an electromagnetic induction system digitizer may be used as the sensor. The following explanation will be given on the assumption that the touchscreen display 17 comprises two different sensors, a digitizer and a touchpanel. However, the present invention is not limited to this assumption, though.

The digitizer is on the lower side of the screen of the flat panel display, for instance. The touchpanel is on the upper side of the screen of the flat panel display, for instance. The touchscreen display 17 can detect not only a touch operation performed on the screen by a finger but also a touch operation performed on the screen by a stylus 100. The stylus 100 includes a digitizer stylus (an electromagnetic induction stylus), an active stylus, a passive stylus, etc.

The user uses an external object (the stylus 100 or the finger) to perform a handwritten input operation on the touchscreen display 17. During the handwritten input operation, the locus of the move of the external object (the stylus 100 or a finger) on the screen, i.e., stroke is rendered in real time. The locus of the move of the external object in a period in which the external object contacts with the screen is equivalent to one stroke. A set of many strokes corresponding to handwritten characters, handwritten figures or handwritten tables constitutes a handwritten document.

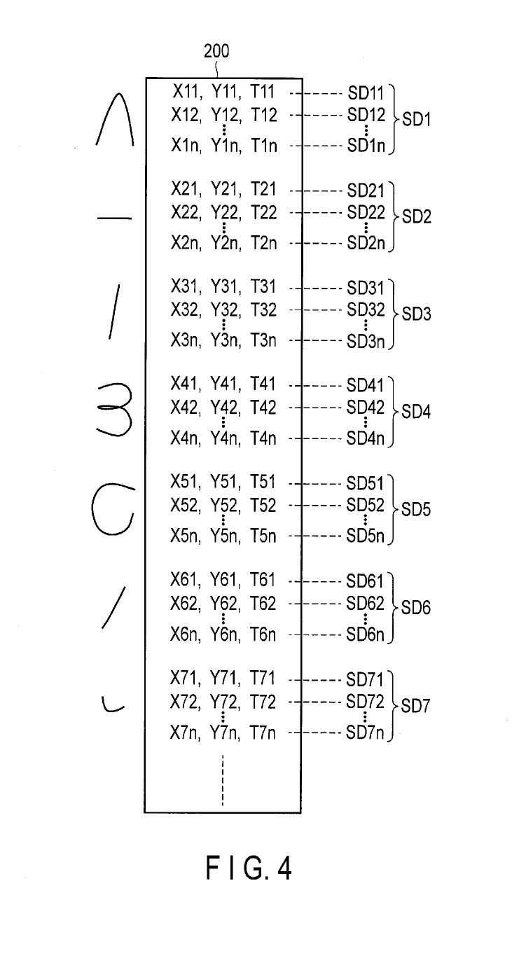

In the present embodiment, the handwritten document is stored in a storage medium not as image data but as time-series data indicating the coordinate series of loci of strokes and the order relationship of the strokes. The time-series data will be explained later in detail with reference to FIG. 4, but the time-series data comprises stroke data sets each indicating a stroke. Each of the stroke data sets corresponds to one stroke, and includes a series of coordinate data items (time-series coordinates) each corresponding to a point on the stroke. The order in which the stroke data sets are arranged corresponds to the stroke order or an order in which the strokes are successively handwritten.

The tablet computer 10 reads from the storage medium any piece of the existing time-series data, and displays on the screen a handwritten document corresponding to the piece of the time-series data, or strokes indicated by the piece of the time-series data. Furthermore, the tablet computer 10 has an editing function. The editing function makes it possible to erase (delete), to copy, to cut, or to move any stroke or any handwritten character within the displayed handwritten document using various tools including an “eraser” tool, a “selection (selection range)” tool, etc. The editing function further includes a function of canceling several handwritten operations or a function of redoing several handwritten operations.

When the “eraser” tool is selected by the user, an erasing mode will be effective. In the erasing mode, a stroke input by the stylus 100 or the finger (“an erasing stroke”) is used for erasing at least one stroke in the handwritten document.

The “eraser” function in the present embodiment has two different erasing functions (erasing modes), a normal erasing function (or a narrow-range erasing function) and a wide-range erasing function allowing rapidly erasing many strokes with ease.

The narrow-range erasing function is a function to erase at least one stroke within a narrow range set in the handwritten document. It is possible that a stroke partially spreading over the narrow range, for instance, may be included in the strokes to be erased. The narrow-range erasing function makes it possible to erase strokes per stroke unit. Alternatively, it is possible to erase only a part of the stroke (a partial stroke) that lies on the narrow range when the stroke is partially spreading over the narrow range. It is possible for the user to erase the handwritten document (strokes) on a stroke basis or on a partial stroke basis when he or she slightly moves the erasing tool.

The wide-range erasing function is a function to collectively erase many strokes within a wide-range set in the handwritten document. Namely, the wide-range erasing function makes it possible to erase the handwritten document (strokes) not per stroke unit but per stroke set unit such as the character, word, sentence, line, paragraph, or page. It is possible for the user to correctively erase with ease many strokes, which reside in a wide range and which the user wants to erase, simply by widely moving the erasing tool to indicate an erasing area.

It should be noted that it is also possible to input any stroke (or any erasing stroke) using a mouse.

FIG. 2 exemplarily illustrates a cooperative operation between the tablet computer 10 and each of the external devices. The tablet computer 10 can cooperate with a personal computer 1 or a cloud. Namely, the tablet computer 10 has a wireless communications device, such as a wireless LAN, and thus can execute wireless communications with the personal computer 1. Furthermore, the tablet computer 10 can execute communications with a server 2 in the Internet. The server 2 may be a server that gives an online storage service or other various cloud computing services.

The personal computer 1 has a storage device such as a hard disk drive (HDD). The tablet computer 10 is capable of sending time-series data (a handwritten document) through the network to the personal computer 1 and causing the personal computer 1 to register the time-series data with the HDD (Upload).

The tablet computer 10 is furthermore capable of reading out at least one handwritten document from the HDD of the personal computer 1 (Download). The tablet computer 10 displays each and every stroke included in the read out handwritten document on the touchscreen display 17 of the tablet computer 10.

It is furthermore possible that the transmission destination of the tablet computer 10 is not the personal computer 1 but the server 2 that is in the cloud and provides a storage service. The tablet computer 10 is capable of sending a handwritten document through the network to the server 2 and causing the server 2 to register the handwritten document with a storage device 2A, which the server 2 has (Upload). The tablet computer 10 is furthermore capable of reading out any handwritten document from the storage device 2A of the server 2 (Download). The tablet computer 10 displays each and every stroke included in the read out handwritten document on the touchscreen display 17 of the tablet computer 10.

In this way, any of the storage device in the tablet computer 10, the storage device in the personal computer 1, and the storage device in the server 2 may be used as a storage medium for storing handwritten documents in the present embodiment.

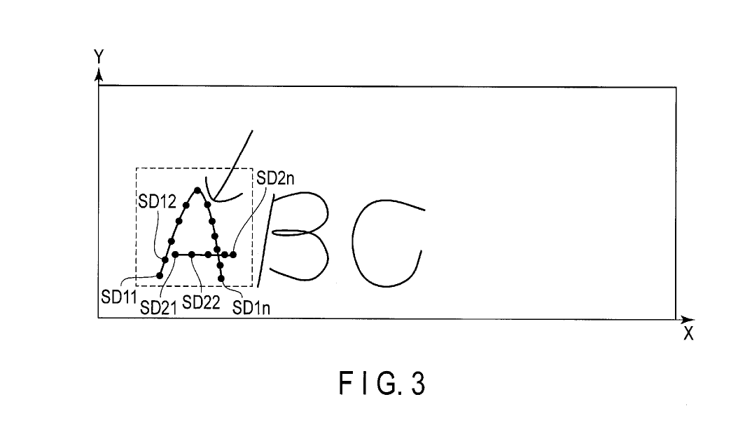

Now, the relation between strokes, handwritten by the user, and a handwritten document will be explained below with reference to FIG. 3 and FIG. 4. FIG. 3 exemplarily illustrates handwritten characters written one by one by hand on the touchscreen display 17 using the stylus 100.

It frequently happens in the handwritten document that a character or a figure is additionally handwritten over a previously handwritten character or a previously handwritten figure. FIG. 3 illustrates a case in which a character string “ABC” is first written by hand in the order of “A,” “B,” and “C.” Then, an arrow mark is additionally drawn by hand immediately near the handwritten character “A.”

The handwritten character “A” may be expressed by two strokes given by moving the stylus 100 by hand (The first stroke has a shape of “ [symbol] ,” and the second stroke has a shape of “-”). The first stroke “ [symbol] ” is sampled in real time at regular time intervals, for instance, and time-series coordinates SD11, SD12, . . . , SD1n are thus obtained for the first stroke “ [symbol] .” In the same way, the second stroke “-” is sampled in real time at regular time intervals, and time-series coordinates SD21, SD22, . . . , SD2n are thus obtained for the second stroke “-.”

The handwritten character “B” may be expressed by two strokes given by moving the stylus 100 by hand. The handwritten character “C” may be expressed by a single stroke given by moving the stylus 100 by hand. The hand-drawn mark “arrow” may be expressed by two strokes given by moving the stylus 100 by hand.

FIG. 4 illustrates time-series data 200 describing the handwritten characters illustrated in FIG. 3. The time-series data 200 includes sets of stroke data SD1, SD2, . . . , SD7. In the time-series data 200, the sets of stroke data SD1, SD2, . . . SD7 are arranged in the handwritten order. Namely, they are arranged in a time-series manner according to the order in which the strokes were given by hand.

Both of the first two sets of stroke data SD1 and SD2 in the time-series data 200 indicate a first two strokes constituting the handwritten character “A.” Both of the third set of stroke data SD3 and the fourth set of stroke data SD4 indicate a second two strokes constituting the handwritten character “B.” The fifth set of stroke data SD5 indicates a single stroke constituting the handwritten character “C.” Both of the sixth set of stroke data SD6 and the seventh set of stroke data SD7 indicate the last two strokes constituting the hand-drawn mark “arrow.”

Each set of stroke data consists of a plurality of coordinates indicating a plurality of points on a single stroke. In each set of stroke data, the coordinates are chronologically arranged, namely, they are arranged according to the order in which the stroke indicated by the coordinates was given by hand. Let us consider the handwritten character “A,” for example. The set of stroke data SD1 consists of the time-series coordinates SD11, SD12, . . . , SD1n, namely, a series of chronologically arranged coordinates chronologically indicating all dots constituting the stroke having the shape of “ [symbol] ” in the handwritten character “A” (coordinates in time-series). The set of stroke data SD2 consists of the time-series coordinates SD21, SD22, . . . , SD2n, namely, a series of chronologically arranged coordinates chronologically indicating all dots constituting the stroke having the shape of “-” in the handwritten character “A.” The number of chronologically arranged coordinates may be different form stroke to stroke.

Each of the chronologically arranged coordinates specifies the X- and Y-coordinates of any dot on the corresponding stroke. For example, the coordinate data SD11 specifies an X-coordinate (X11) and a Y-coordinate (Y11) for a start dot of the “ [symbol] ” shaped stroke. The coordinate data SD1n specifies an X-coordinate (X1n) and a Y-coordinate (Y1n) for an end dot of the “ [symbol] ” shaped stroke.

Each of the coordinate data may include timestamp information T indicating a time when the dot corresponding to the coordinates specified by the coordinate data is handwritten. The time when the dot is handwritten may be absolute time (for instance, year, month, day, hour, minute, and second) or relative time determined by using a certain point of time as a reference. It is possible, for instance, to add as the timestamp information to each of the stroke data sets an absolute time when a stroke begins to be handwritten (for instance, year, month, day, hour, minute, and second), and to add as the timestamp information T a relative time indicating the difference from the absolute time to each piece of the coordinate data in the stroke data.

It is furthermore possible to add writing pressure information (Z) to each of the coordinate data sets.

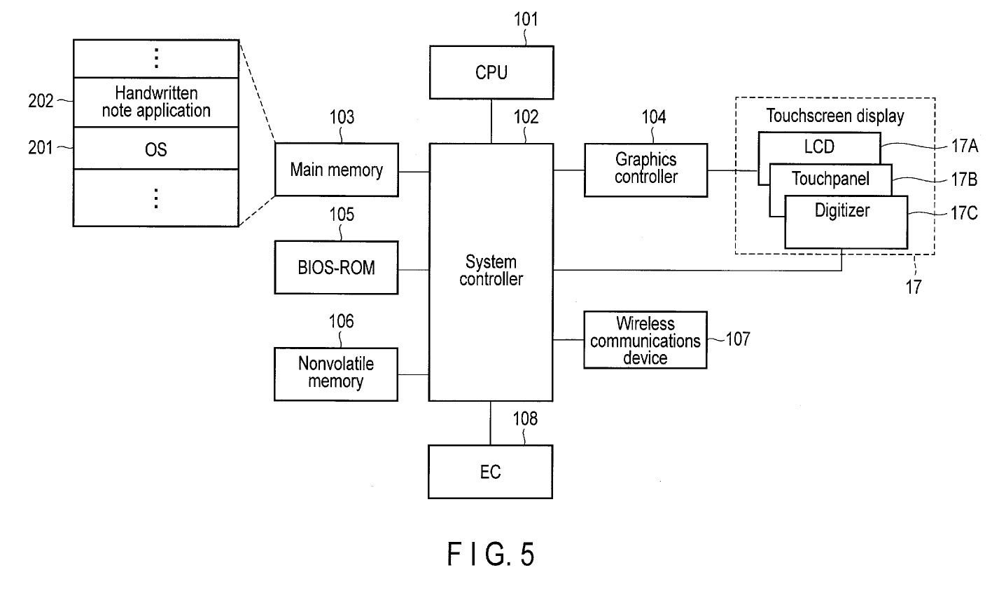

FIG. 5 illustrates a structure of the tablet computer 10.

The tablet computer 10 comprises a CPU 101, a system controller 102, a main memory 103, a graphics controller 104, a BIOS-ROM 105, a nonvolatile memory 106, a wireless communications device 107, an embedded controller (EC) 108, etc., as illustrated in FIG. 5.

The CPU 101 is a processor which controls the operation of various components of the tablet computer 10. The processor includes processing circuitry. The CPU 101 executes various kinds of computer programs loaded from the nonvolatile memory 106, which is the storage device, to the main memory 103. An operating system (OS) 201 and various kinds of application programs may be enumerated as the computer programs. A handwritten note application program 202 is one of the application programs. The handwritten note application program 202 is a digital notebook application capable of taking notes. The handwritten note application program 202 has a function of preparing and displaying a handwritten document, a function of editing the handwritten document, a function of recognizing the handwritten document, etc.

The CPU 101 also executes the basic input-output system (BIOS) stored in the BIOS-ROM 105. The BIOS is a program for hardware control.

The system controller 102 is a device which connects between the various components and the local bus of the CPU 101. A memory controller for executing access control for the main memory 103 is incorporated in the system controller 102. The system controller 102 also has a function of communicating with the graphics controller 104 through, for instance, a serial bus of a PCI Express standard.

The graphics controller 104 is display controller which controls the LCD 17A used as a display monitor of the tablet computer 10. The graphics controller 104 has display control circuitry. When the handwritten note application program 202 is executed, the graphics controller 104 displays on a screen of the LCD 17A a handwritten document, containing handwritten characters each consisting of at least one stroke, under the control of the handwritten note application program 202. The graphics controller 104 generates a display signal and supplies it to the LCD 17A. The LCD 17A displays a screen image based on the display signal. A touchpanel 17B is arranged on the LCD 17A. A digitizer 17c is arranged on the lower side of the LCD 17. It is possible to incorporate the graphics controller 104 into the CPU 101.

The wireless communications device 107 is a device configured to execute wireless communications through a wireless LAN or a 3G mobile communication network, for instance. The wireless communications device 107 has a transmitter configured to transmit a signal and a receiver configured to receive a signal.

The EC 108 is a one-chip microcomputer having an embedded controller for power management. The EC 108 has a function of powering on or off the tablet computer 10 in response to the operation of a power button by the user.

Now, features of the eraser function of the handwritten note application program 202 will be explained below.

The eraser can erase strokes per stroke unit. However, it would be difficult to quickly erase many strokes if the eraser only has the function of erasing strokes per stroke unit.

Therefore, the eraser function in the present embodiment determines that the user wants to erase many strokes when the eraser moves widely, and executes a global erasing operation in which not only strokes directly touched by the eraser but also many other strokes are collectively erased (a wide-range erasure). In the erasing mode, the tip of a stylus will be an eraser, namely, an area defined by (the tip of) a stylus will be an eraser. In the erasing mode, the eraser moves according to the movement of the stylus.

Now, a group of strokes collectively erased will be explained below.

It is possible to erase handwritten characters not per stroke unit but per character unit, per word unit, phrase unit (a group of words which have a particular meaning), per sentence unit, per line unit, or per paragraph unit. In a written document, a sentence is a character string which ends with a period. In a Japanese document, a sentence is a character string which ends with a Japanese full stop. A line of characters is a character string written in a line. In an erasure process for erasing strokes per line unit, all the strokes in a single line of characters will be collectively erased.

Alternatively, all the strokes filling up a whole page may be collectively erased.

The handwritten note application program 202 analyzes a handwritten page, and determines a line structure (which strokes belong to which lines) and paragraphs contained in the handwritten page. The handwritten note application program 202 uses a recognition technique to determine which group of strokes belongs to which character, which word, or which phrase.

In the case of handwritten figures, strokes may be erased per figure object unit such as quadrangle, triangle, or circle.

In the case of handwritten tables, strokes may be erased per ruled line unit, per cell unit, per row unit, per column unit, or per table unit.

The handwritten note application program 202 determines that the user wants to erase only a few strokes when the eraser moves narrowly, and executes a normal erasing operation in which strokes are erased per stroke unit (a narrow-range erasure). It is possible to set the handwritten note application program 202 causing the eraser to erase only a part of the stroke instead of erasing the whole of the stroke in the narrow-range erasure.

In the wide-range erasure, it is possible to set the handwritten note application program 202 making an object of erasure (all strokes related to the wide range) gradually fade away upon erasure. Since the object to be erased disappear gradually, the user can visually identify which part will be erased from the displayed handwritten page. Alternatively, it is possible to display the object to be erased in a special display style using a specific color, and to erase the object after a predetermined time has passed.

The handwritten note application program 202 can cancel the erasing operation when a particular user operation is detected while the object to be erased is fading, namely, before the object to be erased has been completely erased.

Any operation will do for the particular user operation to cancel the erasing operation now in progress. The particular user operation may be, for instance, touching a button for invoking an “UNDO” command with the stylus, or performing a single tap or a double tap with the stylus, or touching the screen with a finger.

The handwritten note application program 202 may determine whether an input operation for inputting erasing stroke is an input operation for a wide-range erasure or not (i.e., whether erasing stroke given by the input operation requests a wide-range erasure or not), based on a moving range (a moving distance) of the stylus, that is, the track size of the erasing stroke. The track size of the erasing stroke corresponds to the size of the locus of the erasing stroke. Namely, an erasing area which is to be erased from the handwritten page may be determined by using at least the track size of the erasing stroke. When the erasing area is wider than a threshold size (i.e., when the erasing area is larger than a first size), the handwritten note application program 202 executes a process of erasing at least one stroke corresponding to the erasing area distinguishable as an object to be erased in an erasing manner. In other words, the handwritten note application program 202 determines that the erasing stroke received in the erasing mode requests a wide-range erasure. The handwritten note application program 202 makes it possible for the user to perceive which strokes correspond to the erasing area and erases all the strokes corresponding to the erasing area.

Whereas, when the erasing area is narrower than or equal to the threshold size (i.e., when the erasing area is not larger than the first size), the handwritten note application program 202 determines that at least one stroke corresponding to the erasing area should be erased. In other words, the handwritten note application program 202 determines that the erasing stroke requests a narrow-range erasure. In this case, the handwritten note application program 202 erases the at least one stroke corresponding to the erasing area in another erasing manner that is different from the erasing manner provided for the wide-range erasure.

Alternatively, it is possible to determine the erasing area by using at least the track size of an erasing stroke and a pressure of the erasing stroke (pressure exerted when the erasing stroke is given). The handwritten note application program 202 may determine whether an erasing stroke given by the input operation requests a wide-range erasure or not based on at least the track size of the erasing stroke and the pressure of the erasing stroke. When the pressure exerted when the erasing stroke is given (the pressure of the erasing stroke) is higher than a threshold pressure, or when the moving range of the stylus (the erasing area) is wider than the threshold range, then the handwritten note application program 202 may determine that the erasing stroke given by the input operation requests a wide-range erasure.

Alternatively, it is possible to determine the erasing area by using the track size of an erasing stroke (the moving range of a stylus), the pressure of the erasing stroke, and the moving speed of the stylus. The handwritten note application program 202 may determine whether an erasing stroke given by the input operation requests a wide-range erasure or not based on the track size of the erasing stroke (the moving range of a stylus) and the pressure of the erasing stroke and the moving speed of the stylus. When any of the pressure exerted when the erasing stroke is given (the pressure of the erasing stroke) or the moving range (distance) of the stylus or the moving speed of the stylus is greater than the corresponding threshold value, then the handwritten note application program 202 determines that the erasing stroke given by the input operation requests a wide-range erasure.

The speed of gradually fading away the object to be erased may be automatically changed in synchronization with the speed of moving the eraser (the stylus). Namely, when the eraser moves quickly, the object to be erased quickly fades out, whereas, when the eraser moves slowly, the object to be erased fades out slowly. This makes it possible for the user to quickly erase many strokes simply by moving the eraser quickly and widely.

It is furthermore possible to dynamically determine whether stokes should be collectively erased per character unit, word unit, phrase unit (plurality of words), sentence unit, line unit, paragraph unit, or page unit with the use of at least one of the moving speed of the stylus, the moving range (distance) of the stylus, and the pressure exerted when the erasing stroke is given (the pressure of the erasing stroke). For instance, the longer the moving range (distance) of the stylus is, the larger unit may be selected. Similarly, the higher the pressure of the erasing stroke is, the larger unit may be selected.

It is needless for the handwritten note application program 202 to determine that an input operation requests a wide-range erasure with the pressure of the erasing stroke, the moving range (distance) of the stylus, or the moving speed of the stylus, as long as the time length (time period) from the input start to the input end of the erasing stroke is shorter than the threshold time length (one second, for instance). Namely, there is no need to execute a wide-range erasure when the time length from the input start to the input end of the erasing stroke is shorter than the threshold time length (one second, for instance). This makes it possible to prevent any incorrect action which may be induced by an erroneously input erasing stroke and incorrectly erases many strokes.

Note that it is possible to configure the handwritten note application program 202 to immediately erase some strokes in the handwritten page when an erasing stroke is given by an input operation by making use of a time period required for determining whether or not the erasing stroke presently given by the input operation requests a wide-range erasure.

If an operation of erasing a small area is performed by the user while a group of strokes is fading away, the eraser function may cancel the wide-range erasing operation now in progress.

It should be noted that, when an erasing stroke is given and when the given erasing stroke extends over some handwritten characters, then a technique of erasing not only several handwritten characters that touch the erasing stroke but also some of the rest handwritten characters that do not touch the erasing stroke but are constituents of the words to which the characters touching the erasing stroke belong may be included in a means of determining an object to be erased for a wide-range erasure. Alternatively, when an erasing stroke is given and when the given erasing stroke extends over some words, then it is possible to include in an object to be erased all strokes that constitute a sentence to which the words concerned belong or a line of words to which the words concerned belong. Furthermore, when an erasing stroke is given and when the given erasing stroke extends over some lines, then it is possible to include all the lines that touch the erasing stroke in an object to be erased.

It should be noted that a technique of erasing an area circumscribing an erasing stroke (for instance, a rectangle circumscribing an erasing stroke) may be included in a means of determining an object to be erased for a wide-range erasure. For instance, if a rectangle circumscribing an erasing stroke encompasses some handwritten characters, all strokes constituting at least one word made up of the handwritten characters encompassed by the rectangle may be erased. Alternatively, when a rectangle circumscribing an erasing stroke encompasses some handwritten words, then it is possible to erase all strokes that constitute a sentence to which the words concerned belong or a line of words to which the words concerned belong. Furthermore, when a rectangle circumscribing an erasing stroke encompasses some lines, all the lines encompassed by the rectangle may be erased.

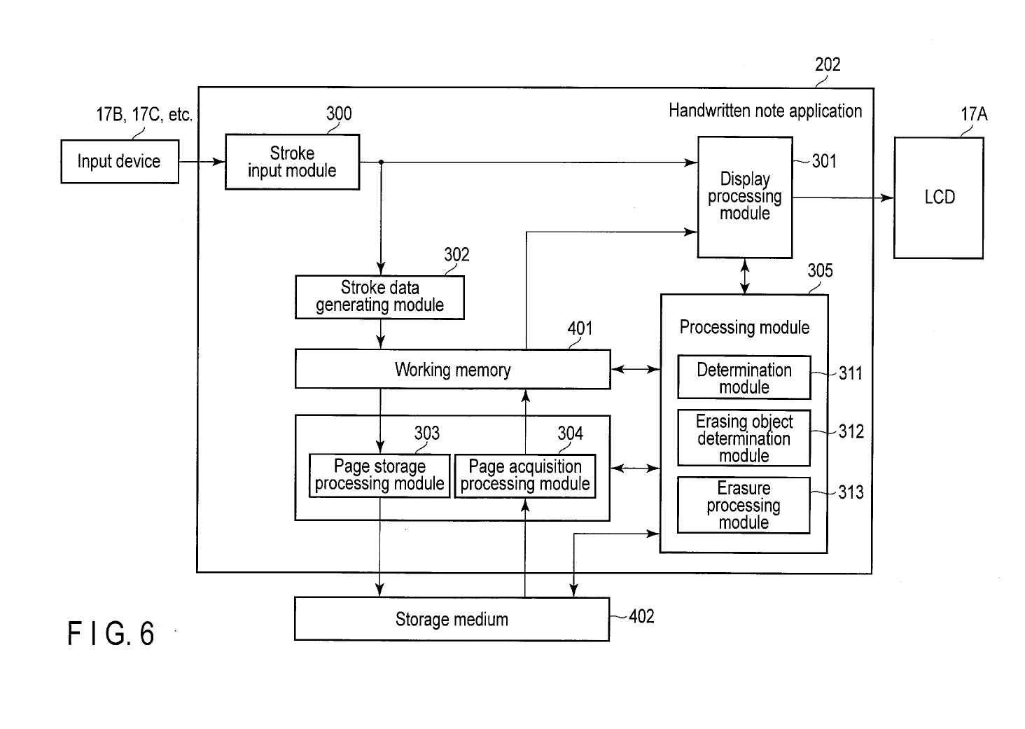

Now, the functional configuration of the handwritten note application program 202 will be explained below with reference to FIG. 6.

The handwritten note application program 202 has, as function executing modules for handling handwritten documents, a stroke input module 300, a display processing module 301, a stroke data generating module 302, a page storage processing unit 303, a page acquisition processing module 304, and a processing module 305.

The handwritten note application program 202 creates, displays, or edits a handwritten page data with making use of stroke data input from the touchscreen display 17. The touchscreen display 17 (the touchpanel 17B, the digitizer 17C) is configured to detect the generation of any event, such as a “touch,” a “move (slide),” a “release,” etc. The “touch” is an event indicating that a stylus or a finger touches the screen. The “move (slide)” is an event indicating that, while a stylus or a finger is in contact with the screen, the contact position between the stylus or finger and the screen moves. The “release” is an event indicating that the stylus or the finger is lifted from the screen.

The stroke input module 300 receives the event such as the “touch” or the “move (slide)” from the touchscreen display 17, thereby detecting the handwritten input operation in the event. The “touch” event includes the coordinate of the contact position. The “move (slide)” event also includes the coordinate of the moved contact position. Therefore, the stroke input module 300 can receive from the touchscreen display 17 a series of coordinates of a stroke given by handwriting.

The display processing module 301 displays on the screen of the LCD 17A a handwritten page (handwritten document) including of strokes. The display processing module 301 receives a series of coordinates from the stroke input module 300 and displays a handwritten strokes on the screen of the LCD 17A based on the series of coordinates. The display processing module 301 furthermore displays on the screen of the LCD 17A strokes contained in the handwritten document having been read out from a storage medium 402.

The stroke data generating module 302 receives the series of coordinates from the stroke input module 300 and generates based on the series of coordinates time-series data having such a structure as having been explained in detail with reference to FIG. 4. It is possible to temporarily store the time-series data into a working memory 401.

The page storage processing unit 303 stores the time-series data (stroke data) in the storage medium 402. The page storage processing unit 303 periodically and automatically saves in the storage medium 402 the handwritten page which is in editing. The page storage processing unit 303 may automatically save in the storage medium 402 the handwritten page which is in editing each time the handwritten note application program 202 is suspended or exits.

The page acquisition processing module 304 acquires from the storage medium 402 the handwritten document which is to be viewed or edited.

The processing module 305 performs various functions for a handwritten page. The processing module 305 erases at least one stroke from a handwritten document (a handwritten page) according to a stroke (an erasing stroke) that is input in the erasing mode. The processing module 305 supports both the narrow-range erasing function and the wide-range erasing function. The processing module 305 performs a process of erasing one or more strokes from the handwritten document in response to an operation for collectively erasing at least one stroke corresponding to the erasing are. The erasing area is determined by at least the track size of the erasing stroke (an additional stroke received in an erasing mode).

The processing module 305 has a determination module 311, an erasing object determination module 312 and erasure processing module 313 as function modules for executing various functions including the narrow-range erasing function and the wide-range erasing function.

The determination module 311 determines which of a wide-range erasing operation or a narrow-range erasing operation should have been input based on whether the erasing area is greater than a threshold size or not. The erasing area is determined by using at least the track size of an erasing stroke (the moving scale of the eraser). The determination module 311 determines whether an input operation for giving an erasing stroke is an operation for collectively erasing a large group of strokes relating to a wide range greater than the threshold size (a wide-range erasing operation) or an operation for erasing at least one stroke relating to a narrow range less than the threshold size (a narrow-range erasing operation) based on whether or not the erasing area determined by using at least the track size of the erasing stroke (the moving scale of the eraser) is greater than a threshold size.

When the erasing area is greater than the threshold size, namely, when the stylus 100 widely moves over the handwritten page, then the determination module 311 determines that the input operation should be a wide-range erasing operation. Whereas when the erasing area is less than the threshold size, namely, when the stylus 100 only slightly moves on the handwritten page, then the determination module 311 determines that the input operation should be a narrow-range erasing operation. The erasing area may be determined based on the external form of the locus of the erasing stroke (for instance, a rectangle circumscribing the erasing stroke).

The erasing object determination module 312 determines an erasing object corresponding to a wide range for the wide-range erasure or an erasing object corresponding to a narrow range for the narrow-range erasure.

In the narrow-range erasure, the erasing object determination module 312 determines as an erasing object at least one stroke as long as it partly or wholly belongs to the erasing area.

In the wide-range erasure, the erasing object determination module 312 determines a group of strokes to be an erasing object as long as the group of strokes partly or wholly belongs to the erasing area (namely, those characters, words, phrases, sentences, lines, paragraphs, figures, tables, or the like that partly or wholly belong to the erasing area).

In the wide-range erasure, many strokes are an object to be erased. Therefore, it is preferable to present to the user which strokes will be erased before erasing the object to be erased.

In the wide-range erasure, therefore, the erasure processing module 313 may erase a group of strokes corresponding to the erasing area distinguishable as an object to be erased in the erasing manner. Thus, the erasure processing module 313 can allow the user to perceive which strokes are connected with the erasing area when it erases all the strokes connected with the erasing area. The erasure processing module 313 may spend a certain time on making the group of strokes gradually transparent, or alternatively may display the group of strokes with a certain color for a certain time, and may erase them after the certain time has passed. This makes it possible to present to the user which strokes will be erased before erasing the object to be erased.

It is possible that the aforementioned certain time, namely, the length of time till the group of strokes are erased may dynamically change according to the size of the object to be erased (i.e., a size of the erasing area). For instance, if the erasing area (a wide range) is less than a certain threshold size, it may take a first time to erase the group of strokes. In contrast, if the erasing area (a wide range) is greater than the certain threshold size, it may take a second time longer than the first time to erase the group of strokes.

In the narrow-range erasure, the erasure processing module 313 erases strokes corresponding to an erasing area (a narrow range) in an erasing manner different from the aforementioned erasing manner.

In the narrow-range erasure, the erasing area is so narrow that any stroke touched by the stylus alone will be fundamentally erased. An object to be erased is only one or more strokes, which the user wants to erase. Therefore, there is almost no need to present to the user an object to be erased.

In the narrow-range erasure, the erasure processing module 313 may erase one or more strokes relating to an erasing area (a narrow range) within a time shorter than the aforementioned first time. That is to say, the erasure processing module 313 may erase them without almost any delay. For instance, the erasure processing module 313 may erase the strokes relating to the erasing area (the narrow range) immediately after it has been determined which strokes belong to the object of erasure connected with the erasing area (the narrow range).

In this way, the present embodiment makes it possible to automatically select one of the two erasing manners according to a wide-range erasure or a small range erasure.

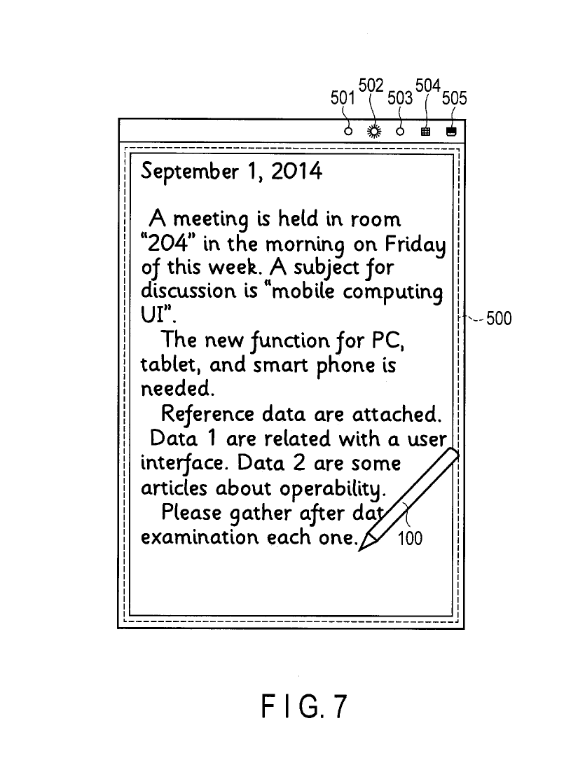

FIG. 7 illustrates an editing view which is displayed on the screen by the handwritten note application program 202.

The editing view is a display area for creating a new handwritten page, or for viewing or editing the existing handwritten pages.

In the editing view, a rectangular region 500 surrounded by a broken line is a handwriting input area which allows handwriting input. In the handwriting input area 500, an input event from the digitizer 17C or the like may be used for displaying (rendering) the handwritten strokes. An input event from the touchpanel 17B may not be used for inputting and displaying (rendering) the handwritten strokes, but may be used for indicating gestures (finger gestures) such as a tap, a swipe, etc.

The editing view furthermore displays a quick select menu including three pens 501-503, which may be registered in advance by the user, a selector pen 504, and an erasure pen 505. It is assumed here that a black pen 501, a red pen 502 and a marker 503 are registered in advance by the user. The user taps one of the pens (buttons) with a stylus 100 or with his or her finger to change the kind of the pen which he or she wants to use. For instance, when the handwritten input operation is executed on the editing view with the use of the stylus 100 under the condition that the black pen 501 is selected by the stylus 100 or the finger, the handwritten note application program 202 renders a black stroke on the editing view (handwritten page) in accordance with the movement of the stylus 100, whereby the black stroke will be simultaneously displayed on the editing view as the stylus 100 moves.

It is possible to change the aforementioned three kinds of pens provided in the quick select menu by the operation of the side buttons of the stylus 100. It is possible to set a combination of color and thickness, which the user frequently uses, for each of the aforementioned three kinds of pens provided in the quick select menu.

The erasure pen 505 is a button for using an erasure tool. The erasure pen 505 is used for changing the erasing mode between on or off.

When the erasing mode is on (active), the handwritten note application program 202 deals with an input stroke as an erasing stroke.

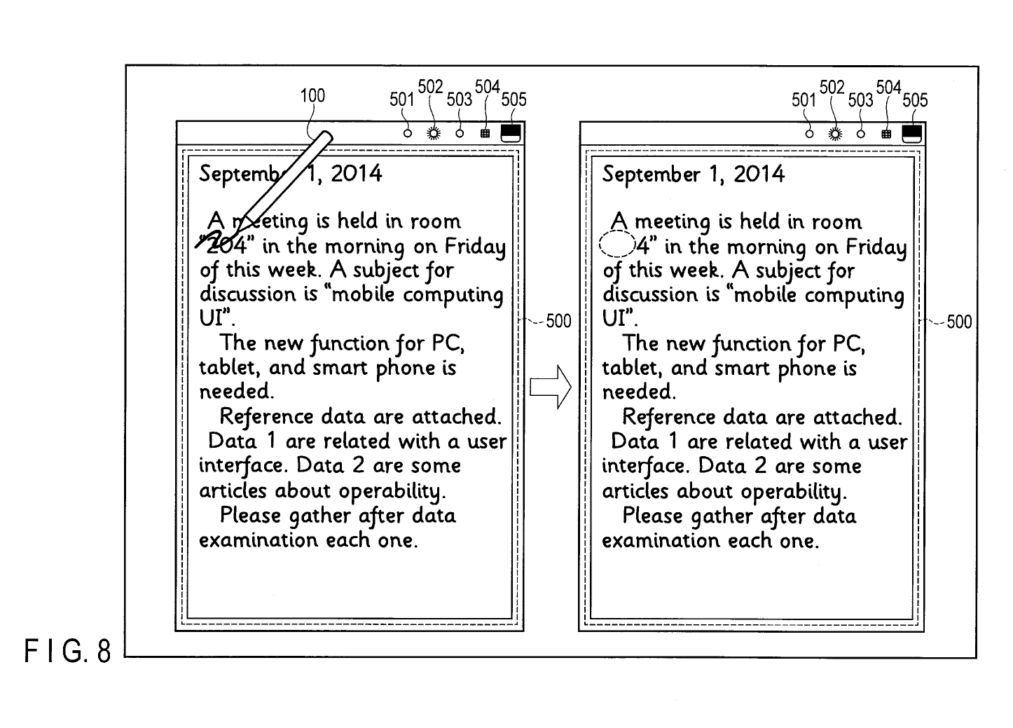

FIG. 8 illustrates an example of a narrow-range erasure.

In the erasing mode, when the moving range of the stylus 100 or the track size of the erasing stroke is small in size as illustrated on the left side of FIG. 8, the handwritten note application program 202 erases only one or more strokes included in the erasing area (the narrow range) determined by the size of the track size the erasing stroke (the narrow-range erasure). It should be noted that the erasing stroke is illustrated by a solid line on the left side of FIG. 8, but actually there is no need to display the locus of the erasing stroke.

In the narrow-range erasure, it is possible to determine that the range specified by the locus of the erasing stroke (line extending along the locus of the erasing stroke) should be an erasing area. Alternatively, it is possible to determine that the rectangle circumscribing the erasing stroke should be an erasing area.

When the erasing stroke extends over some strokes constituting a string of handwritten characters ““20” as illustrated on the left side of FIG. 8, these strokes alone will be erased as illustrated on the right side of FIG. 8.

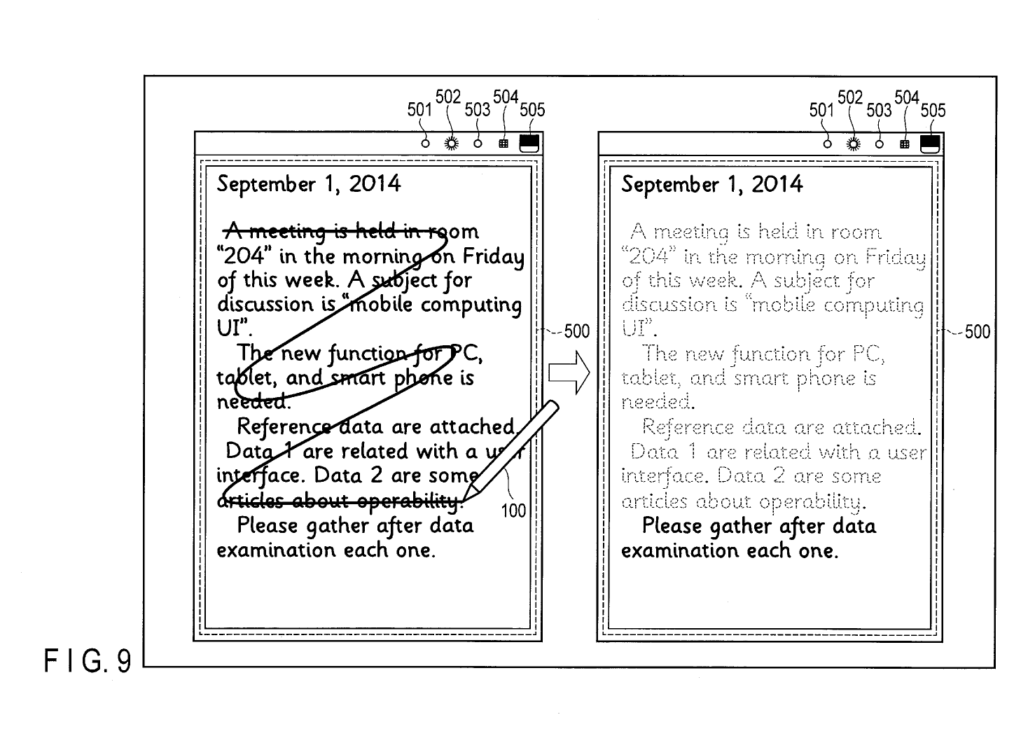

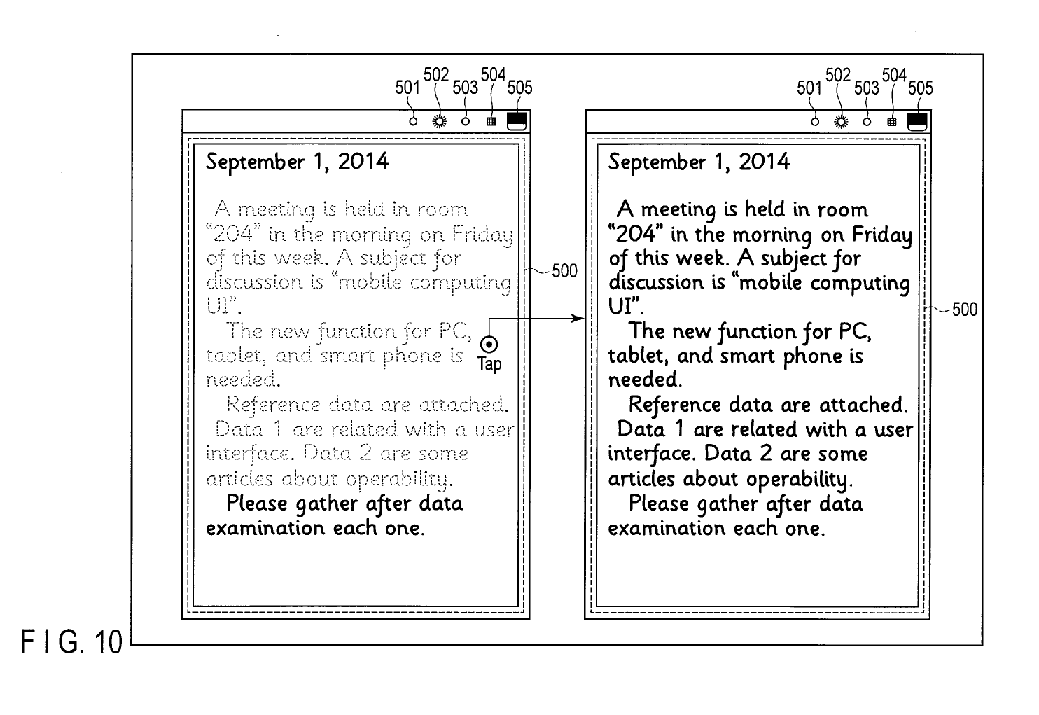

FIG. 9 illustrates an example of a wide-range erasure.

In the erasing mode, when the moving range of the stylus 100 or the track size of the erasing stroke is large in size as illustrated on the left side of FIG. 9, the handwritten note application program 202 collectively erases a group of strokes included in the erasing area (the wide range) determined by the size of the locus of the erasing stroke (the wide-range erasure).

In the wide-range erasure, it is possible to determine that the rectangle circumscribing the erasing stroke or the range wider than the rectangle should be an erasing area. For instance, when the erasing stroke extends over 12 lines of characters (three paragraphs) as illustrated on the left side of FIG. 9, the range specified by the 12 lines of characters may be determined as an erasing area. Alternatively, the handwritten note application program 202 may determine that the rectangle circumscribing the erasing stroke should be an erasing area.

The handwritten note application program 202 collectively erases a group of strokes at least partially belonging to the erasing area. For instance, all the lines of characters at least partially belonging to the erasing area are collectively erased.

The group of strokes to be erased will fade away as illustrated on the right side of FIG. 9. The group of strokes illustrated by broken lines on the right side of FIG. 9 is a group of strokes to be erased.

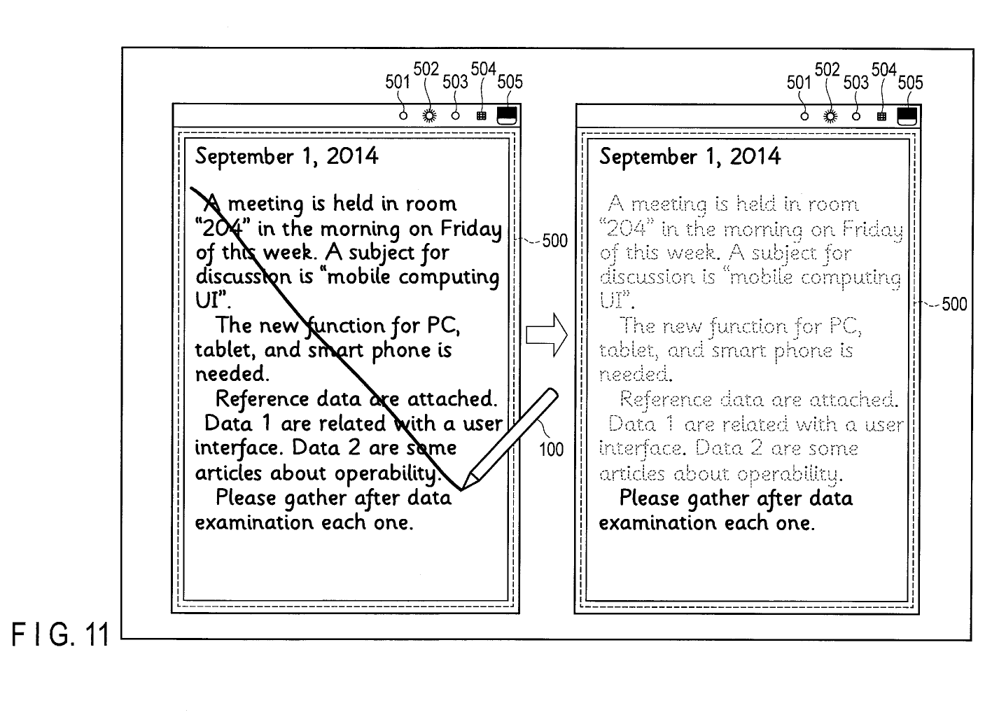

When the erasing area is tapped in the process of fading away as illustrated on the left side of FIG. 10, the handwritten note application program 202 cancels the erasure of the group of strokes and restores the display style of the group of strokes as illustrated in the right side of FIG. 10.

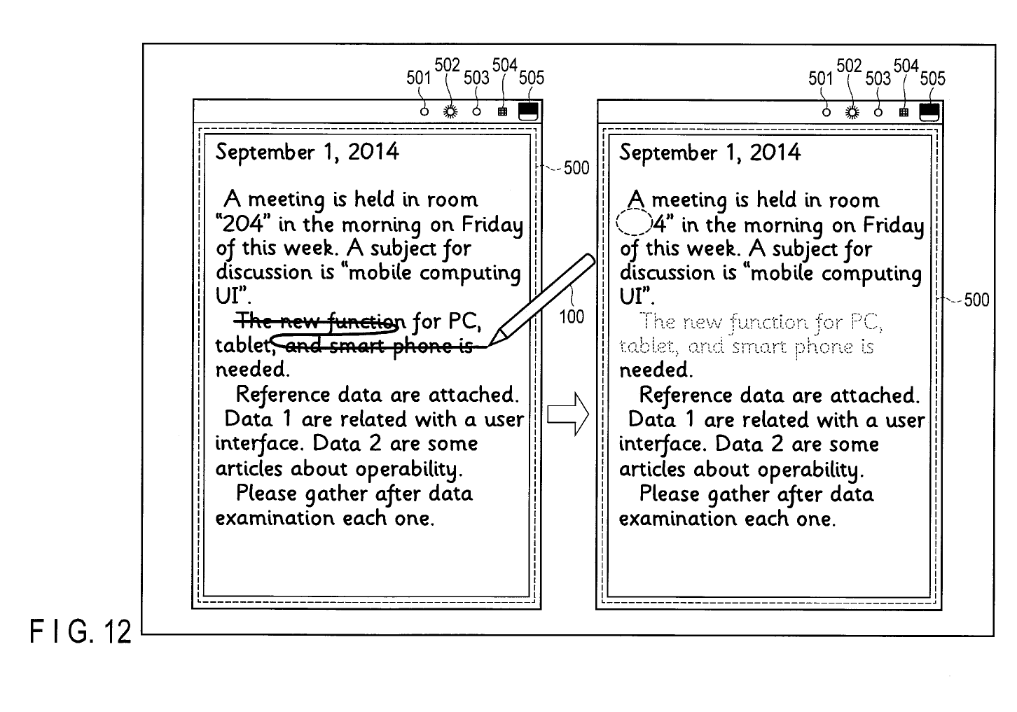

Incidentally, the movement of the stylus 100 for invoking a wide-range erasure is not limited to the example illustrated in FIG. 9. For instance, as illustrated on the left side of FIG. 11, it is possible to move the stylus 100 form the upper end to the lower end of a region where the user wants to erase.

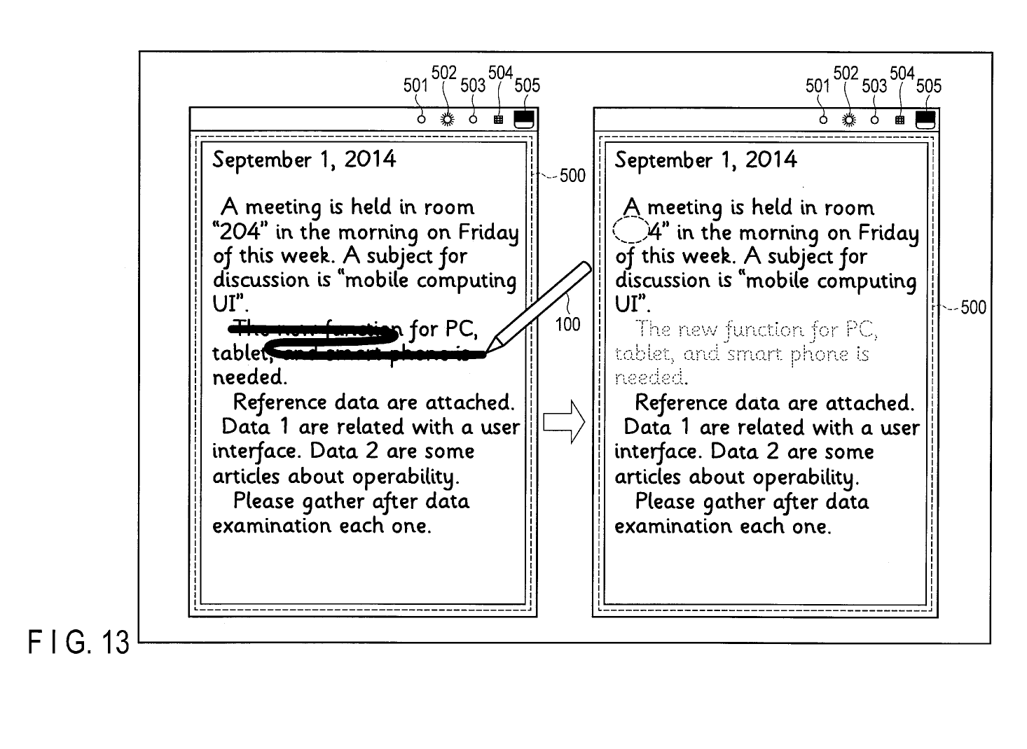

FIG. 12 illustrates another example of the wide-range erasure.

The left side of FIG. 12 illustrates an example in which an erasing stroke given by the user extends over two lines of characters. The group of strokes connected with the two lines of characters is determined to be a group of strokes to be erased. The group of strokes to be erased will fade away as illustrated on the right side of FIG. 12.

FIG. 13 illustrates still another example of the wide-range erasure.

The left side of FIG. 13 illustrates an example in which an erasing stroke given by the user extends over two lines of characters and the pressure exerted when the erasing stroke is given is higher than a threshold pressure. In this case, as illustrated on the right side of FIG. 13, a region wider than the region illustrated on the right side of FIG. 12 will be determined as an erasing area, and the group of strokes connected with the erasing area may be erased.

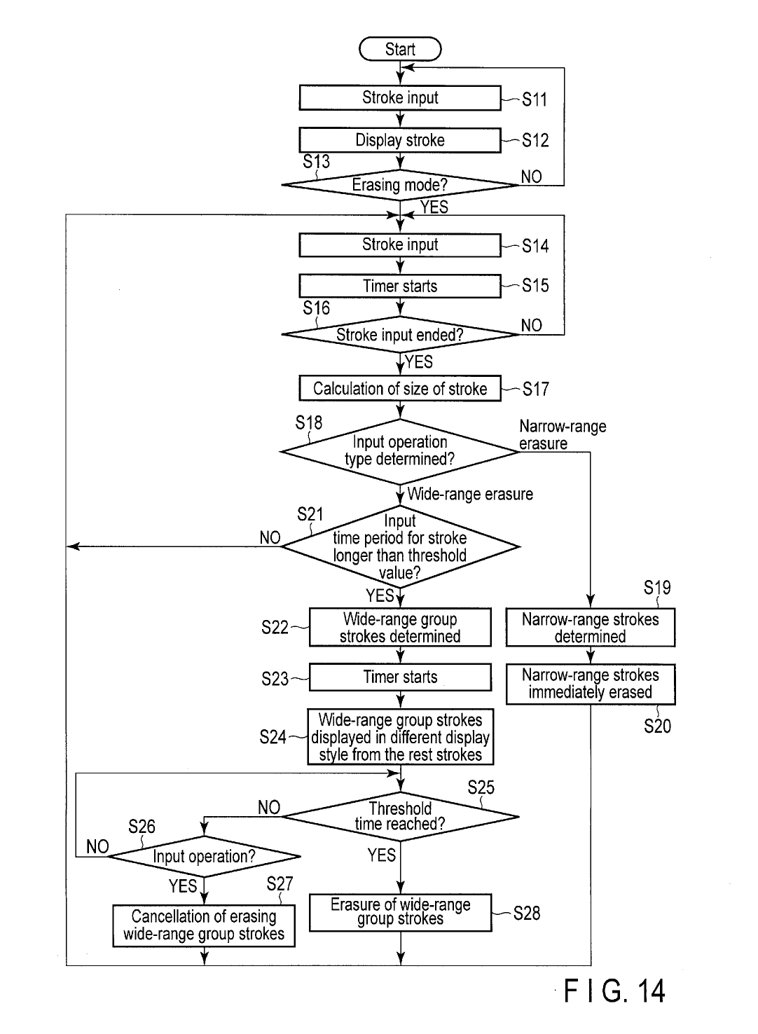

The flowchart of FIG. 14 illustrates an erasing process for erasing strokes in response to the operation of an eraser.

The CPU 101 executes the handwritten note application program 202 and performs the following process.

The CPU 101 receives from the touchscreen display 17 strokes that are input by an input operation using the stylus 100 (Step S11). The CPU 101 executes a process for displaying strokes given by the handwritten input on the screen of the touchscreen display 17 in cooperation with the graphics controller 104 (Step S12). A handwritten document (a handwritten page) will be displayed on the screen of the touchscreen display 17.

When the erasure pen 505 is tapped by the stylus 100 or the finger, the CPU 101 determines that an erasing mode should be active (YES in Step S13).

In the erasing mode, the CPU 101 receives from the touchscreen display 17 a stroke (an erasing stroke) that is input by an input operation using the stylus 100 (Step S14). The erasing stroke is an additional stroke received in the erasing mode.

At a moment when the input of the erasing stroke begins, or at a moment when the coordinate of the head point of the erasing stroke is received, the CPU 101 starts its timer (Step S15). When the stylus 100 is lifted from the screen by a stylus-up operation, the input of the erasing stroke ends.

When the input of the erasing stroke ends (YES in Step S16), the CPU 101 calculates the track size of the erasing stroke (the size of the locus of the erasing stroke). More specifically, the CPU 101 calculates the size of the erasing area determined by using the track size of the erasing stroke (Step S17). In step S17, the CPU 101 may calculate the size of the external form of the erasing stroke as the size of the erasing area. The external form of the erasing stroke may be a rectangle circumscribing the erasing stroke.

The CPU 101 determines whether the size of the erasing area is larger than a first size (Step S18). In other words, the CPU 101 determines whether an input operation for inputting the erasing stroke is an operation for collectively erasing a group of strokes relating to a wide range greater than the threshold size (a wide-range erasing operation) or an operation for erasing at least one stroke relating to a narrow range less than the threshold size (a narrow-range erasing operation) based on the size of the erasing area or the track size of the erasing stroke (Step S18). The CPU 101 determines which of a wide-range erasing operation or a narrow-range erasing operation should have been input based on whether the erasing area is greater than a threshold size or not.

In Step S18, it is possible for the CPU 101 to use not only the track size of the erasing stroke but also the pressure of the erasing stroke upon determination of whether the erasing stroke given by the input operation requests a wide-range erasure or a narrow-range erasure. In this case, the erasing area may be determined by using both the track size of the erasing stroke and the pressure of the erasing stroke.

If the erasing area is narrower than or equal to the threshold size (first size), the CPU 101 determines that the erasing stroke given by the input operation requests a narrow-range erasure. In other words, the CPU 101 determines that what is input is a request to erase at least one stroke relating to the erasing area (the narrow range). The CPU 101 determines that the at least one stroke corresponding to the erasing area (the narrow range) should be an object to be erased (Step S19). In Step S19, any stroke at least partially relating to the erasing area (the narrow range) may be determined as an object to be erased. The CPU 101 immediately erases strokes that belong to the object to be erased (Step S20).

If the erasing area is wider than the threshold size (first size), the CPU 101 determines whether the length of time required for giving the erasing stroke or the length of time from the beginning to the end of giving the erasing stroke should last longer than a threshold length of time (for instance, one second) (Step S21).

If the beginning to the end of giving the erasing stroke is shorter than the threshold length of time (NO in Step S21), the CPU 101 does not determine that the erasing stroke given by the input operation requests a wide-range erasing operation for a wide-range erasure. The process advances to Step S14.

Whereas, if the erasing area is wider than the threshold size, and if the beginning to the end of giving the erasing stroke is longer than the threshold length of time (YES in Step S21), the CPU 101 does determine that the erasing stroke given by the input operation requests a wide-range erasing operation for a wide-range erasure. In other words, the CPU 101 determines that what is input is a request to erase a group of strokes relating to the erasing area (the wide range). The CPU 101 determines that a group of strokes corresponding to the erasing area should be an object to be erased (Step S22). In Step S22, the group of strokes corresponding to the erasing area may be determined as an object to be erased.

The group of strokes may be at least one stroke relating to at least one of handwritten characters, handwritten words, handwritten sentences, handwritten lines, or handwritten paragraphs.

The CPU 101 begins to erase the group of strokes which is the object to be erased. The CPU 101 first starts the timer (Step S23). Then, the CPU 101 displays the group of strokes in a specified display style different from the rest strokes (Step S24). In Step S24, the group of strokes, which is the object to be erased, may be differently displayed in color from the rest strokes. Alternatively, the group of strokes may become gradually transparent to indicate which the object to be erased is.

The CPU 101 determines whether or not the elapsed time since the group of strokes, the object to be erased, is displayed in a specified style reaches the threshold time (Step S25). If a specified user operation (for instance, an input operation such as a tap) is detected before the elapsed time has reached the threshold time or before the group of strokes, the object to be erased, have been erased (YES in Step S26), the CPU 101 cancels the erasure of the group of strokes which is the object to be erased (Step S27).

If the elapsed time has reached the threshold time without any specified user operation (YES in Step S25), the CPU 101 collectively erases the group of strokes, the object to be erased.

As having been explained above, the present embodiment makes it possible for the user to erase many strokes with ease only by moving the eraser widely. Furthermore, when the erasing area is larger than the first size, a first process of erasing at least one stroke distinguishable as an object to be erased in a first erasing manner is executed. Therefore, the user can easily confirm which part will be erased from the handwritten page.

Although a case in which a stroke (an erasing stroke) is given by a stylus or a finger has been explained as an example of the present embodiment, the stroke (the erasing stroke) may be given by a mouse.

Furthermore, the various functions of the present embodiment having been described above may be achieved by circuitry. The circuitry includes a programmed processor such as a central processing unit (CPU). The processor executes computer programs (a group of commands) stored in the memory to perform the aforementioned various functions. The processor may be a microprocessor including electric circuits. The circuitry includes a digital signal processor (DSP), an application-specific integrated circuit (ASIC), a microcontroller, a controller, and the other electric circuit components. The components other than the CPU having been described above when explaining the present embodiment may be achieved by various processing circuits.

Furthermore, every process in the present embodiment may be executed by a suitable computer program. Therefore, if all computer programs necessary for executing all functions of the present embodiment are stored in a computer readable storage medium, then all that is necessary for obtaining the same advantage as the present embodiment would be simply to install the computer programs from the computer readable storage medium onto a computer and to execute the installed programs.

Although a case in which a tablet computer is used has been explained as an example of the present embodiment, various functions of the present embodiment may be achieved by a common desktop personal computer. In such a case, all that is required is connecting an input device for handwritten input such as a tablet to the desktop personal computer.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display controller configured to display on a screen a handwritten document comprising a plurality of strokes;
circuitry configured to perform a process of erasing one or more strokes from the handwritten document in response to an operation for collectively erasing at least one stroke corresponding to an erasing are, the erasing area determined by at least a track size of an additional stroke received in an erasing mode,
wherein the circuitry is configured to execute, when the erasing area is larger than a first size, a first process of erasing at least one stroke distinguishable as an object to be erased in a first erasing manner,
wherein the circuitry is configured to execute, when the erasing are is not larger than the first size, a second process of erasing at least one stroke in a second erasing manner different from the first erasing manner.

2. The electronic device of claim 1, wherein the at least one stroke corresponding to the erasing area distinguishable in the first erasing manner is erased within a first time period, wherein the at least one stroke corresponding to the erasing area in the second erasing manner is erased within a second time period, the second time period less than the first time period.

3. The electronic device of claim 2, wherein the circuitry is configured to cancel the erasure of the at least one stroke corresponding to the erasing area larger than the first size upon a user operation received before the at least one stroke corresponding to the erasing area is erased.

4. The electronic device of claim 1, wherein the erasing area is determined based on at least a track size of the additional stroke and a pressure of the additional stroke.

5. The electronic device of claim 1, wherein the circuitry is configured to not execute the first process when a time period from the start to the end of the additional stroke is shorter than a third time period.

6. A method comprising:
displaying on a screen a handwritten document comprising a plurality of strokes;
erasing one or more strokes from the handwritten document in response to an operation for collectively erasing at least one stroke corresponding to an erasing are, the erasing area determined by at least a track size of an additional stroke received in an erasing mode;
executing, when the erasing area is larger than a first size, a first process of erasing at least one stroke distinguishable as an object to be erased in a first erasing manner; and
executing, when the erasing are is not larger than the first size, a second process of erasing at least one stroke in a second erasing manner different from the first erasing manner.

7. The method of claim 6, wherein the at least one stroke corresponding to the erasing area distinguishable in the first erasing manner is erased within a first time period, wherein the at least one stroke corresponding to the erasing area in the second erasing manner is erased within a second time period, the second time period less than the first time period.

8. The method of claim 7, wherein the erasure of the at least one stroke corresponding to the erasing area larger than the first size is cancelled upon a user operation received before the at least one stroke corresponding to the erasing area is erased.

9. The method of claim 6, wherein the erasing area is determined based on at least a track size of the additional stroke and a pressure of the additional stroke.

10. The method of claim 6, wherein the first process is canceled when a time period from the start to the end of the additional stroke is shorter than a third time period.

11. A non-transitory computer-readable medium storing a computer program executable by a computer, the computer program causing the computer to execute functions of:
displaying on a screen a handwritten document comprising a plurality of strokes;
erasing one or more strokes from the handwritten document in response to an operation for collectively erasing at least one stroke corresponding to an erasing are, the erasing area determined by at least a track size of an additional stroke received in an erasing mode;
executing, when the erasing area is larger than a first size, a first process of erasing at least one stroke distinguishable as an object to be erased in a first erasing manner; and
executing, when the erasing are is not larger than the first size, a second process of erasing at least one stroke in a second erasing manner different from the first erasing manner.

12. The computer-readable medium of claim 11, wherein the at least one stroke corresponding to the erasing area distinguishable in the first erasing manner is erased within a first time period, wherein the at least one stroke corresponding to the erasing area in the second erasing manner is erased within a second time period, the second time period less than the first time period.

13. The computer-readable medium of claim 12, the erasure of the at least one stroke corresponding to the erasing area larger than the first size is cancelled upon a user operation received before the at least one stroke corresponding to the erasing area is erased.

14. The computer-readable medium of claim 11, wherein the erasing area is determined based on at least a track size of the additional stroke and a pressure of the additional stroke.

15. The computer-readable medium of claim 11, wherein the first process is canceled when a time period from the start to the end of the additional stroke is shorter than a third time period.
